(19) United States
(12) Patent Application Publication
(10) Pub. No.: US 2007/0190877 A1
(43) Pub. Date: Aug. 16, 2007

(54) Flame retardant knit fabric

(76) Inventors: Wataru Mio, Kobe-shi (JP); Masahiko Mihoichi, Kobe-shi (JP)

Correspondence Address: BIRCH STEWART KOLASCH & BIRCH, PO BOX 747, FALLS CHURCH, VA, 22040-0747, US

(21) Appl. No.: 11/631,940

(22) PCT Filed: Jun. 17, 2005
(86) PCT No.: PCT/JP05/11163

§ 371 Date: Mar. 1, 2007

(30) Foreign Application Priority Data
Jul. 15, 2004 (JP) 2004-209082

(51) Int. Cl. B32B 27/12; B32B 27/04; D04B 21/00

(52) U.S. Cl. 442/136; 442/304; 442/143

(57) ABSTRACT

There is provided a flame-retardant knit fabric that sufficiently provides texture and amenity inherent in cotton or urethane foam as a material used in upholstered furniture such as mattresses and chairs, bedding products such as pillows, mattress pads, and futon, and the like, and can make these products highly flame-retardant. The present invention relates to a knit fabric comprising at least two fibers selected from the group consisting of (A) a halogen-containing fiber, (B) a cellulosic fiber, (C) a flame-retardant cellulosic fiber, and (D) a polyester fiber, the knit fabric having a weight per unit area of 150 g/m² or more, having a thickness of 0.5 mm or more, and having a content of a flame retardant in the whole knit fabric of 2 wt % or more, wherein (weight per unit area of the knit fabric (g/m²))×(thickness of the knit fabric (mm))×(content of the flame retardant in the whole knit fabric (wt %)/100)=10 or more.

### TECHNICAL FIELD

The present invention relates to a flame-retardant knit fabric having flame-shielding performance, which comprises a fiber selected from the group consisting of (A) a halogen-containing fiber, (B) a cellulosic fiber, (C) a flame-retardant cellulosic fiber, and (D) a polyester fiber and is suitably used for upholstered furniture such as mattresses and chairs and bedding products such as pillows, mattress pads, and futon.

### BACKGROUND ART

For prevention of fire, a material used for household furniture, bedding, or the like is preferably provided with flame retardance.

Flammable materials such as cotton and urethane foam are used in furniture or bedding for comfortable use. Thus, for flameproofing, it is important to prevent flaming of the flammable materials over a long time. Further, the flammable materials must not impair comfort and design properties of furniture or bedding.

Although various flame-retardant fibers and fire protection chemicals have been studied in the past, no flame-retardant fibers and fire protection chemicals have been developed which sufficiently have the high flame retardance and meet the requirements for furniture or bedding materials.

For example, there is a method called post-processing fire protection in which a fire protection chemical is applied to a woven fabric such as a cotton fabric. This method has drawbacks in that fire-protecting performance varies due to non-uniform adhesion of the fire protection chemical, and feeling and comfort is decreased due to hardening of the fabric caused by adhesion of the fire protection chemical.

When polyester as a general-purpose material is used as a main material, the polyester, if forcibly burned, has a hole formed therein due to melting or burning and thus cannot maintain the structure, because it cannot be a carbonized component. Therefore, polyester has quite insufficient flame retardance to prevent flaming of the above-described cotton or urethane foam used in bedding or furniture.

A fabric from a heat-resistant fiber has excellent flame retardance but is extremely expensive. Furthermore, the fabric is inferior in processability in opening, hygroscopicity, and feeling, and is difficult to have a color design with high design properties due to its inferior dyeing properties, disadvantageously.

As materials that improve these drawbacks of the furniture or bedding materials, provide excellent texture, hygroscopicity, and feeling required as general properties, and have stable flame retardance, there have been proposed an interior textile product (Patent Document 1) and a bedding textile product (Patent Document 2) from a flame-retardant fiber composite comprising a combination of a halogen-containing fiber having high flame retardance to which a large amount of a flame retardant is added with another fiber that does not have flame retardance. However, these textile products are still to be technically improved. There have also been proposed a bulky flame-retardant nonwoven fabric comprising an essentially flame-retardant fiber and a halogen-containing fiber (Patent Document 3), a flame-retardant nonwoven fabric comprising a halogen-containing polyacrylonitrile fiber and a fiber that supports the polyacrylonitrile fiber when burned (Patent Document 4), and a flame-retardant nonwoven fabric comprising a flame-retardant rayon fiber, flame-retardant acrylic fiber, or flame-retardant melamine fiber (Patent Document 5). However, any of the flame-retardant nonwoven fabrics is a technology using a nonwoven fabric, and thus is a flame-retardant technology that lacks soft touch and stretch properties as in a knit fabric, cannot sufficiently provide texture and amenity inherent in cotton or urethane foam as a material used in bedding or furniture, and provides inferior comfort.

Patent Document 1: Japanese Patent Laid-open No. 05-106132

Patent Document 2: Japanese Patent Laid-open No. 05-093330

Patent Document 3: WO03/023108

Patent Document 4: US2004/0062912A1

Patent Document 5: US2004/0097156A1

### DESCRIPTION OF THE INVENTION

The present invention has achieved an object to obtain a flame-retardant knit fabric that sufficiently provides texture and amenity inherent in cotton or urethane foam as a material used in upholstered furniture such as mattresses and chairs, bedding products such as pillows, mattress pads, and futon, and the like, and that can make these products highly flame-retardant, the object which cannot be achieved by conventional flame-retardant fiber composites and flame-retardant woven and nonwoven fabrics.

As a result of extensive studies to achieve the above object, the present inventors have found that a flame-retardant knit fabric having flame retardance to allow the fabric to resist the flame over a long time without impairing comfort such as texture and feeling in upholstered furniture or bedding products can be obtained by preparing a novel flame-retardant knit fabric from at least two fibers selected from the group consisting of (A) a halogen-containing fiber, (B) a cellulosic fiber, (C) a flame-retardant cellulosic fiber, and (D) a polyester fiber.

Specifically, the present invention relates to the following knit fabrics:

a flame-retardant knit fabric comprising at least two fibers selected from the group consisting of (A) a halogen-containing fiber, (B) a cellulosic fiber, (C) a flame-retardant cellulosic fiber, and (D) a polyester fiber, the knit fabric having a weight per unit area of 150 g/m² or more, having a thickness of 0.5 mm or more, and having a content of a flame retardant in the whole knit fabric of 2 wt % or more, wherein (weight per unit area of the knit fabric (g/m²))×(thickness of the knit fabric (mm))×(content of the flame retardant in the whole knit fabric (wt %)/100)=10 or more (claim 1);

the flame-retardant knit fabric according to claim 1, wherein the halogen-containing fiber (A) is a modacrylic fiber (claim 2);

the flame-retardant knit fabric according to claim 1, wherein the cellulosic fiber (B) is at least one fiber selected from the group consisting of cotton, hemp, rayon, polynosic, cupro, acetate, and triacetate (claim 3); the flame-retardant knit fabric according to claim 3, wherein the cellulosic fiber (B) is a cotton fiber (claim 4);

the flame-retardant knit fabric according to claim 1, wherein the flame-retardant cellulosic fiber (C) is at least one fiber selected from the group consisting of cotton, hemp, rayon, polynosic, cupro, acetate, and triacetate (claim 5);

the flame-retardant knit fabric according to claim 5, wherein the flame-retardant cellulosic fiber (C) is a rayon fiber containing 20 to 50 wt % of a flame retardant selected from silicic acid and aluminum silicate (claim 6),

the flame-retardant knit fabric according to claim 5 or 6, wherein the flame-retardant cellulosic fiber (C) is the cellulosic fiber (B) to which 6 to 25 wt % of a flame retardant selected from the group consisting of a phosphoric acid ester compound, a halogen-containing phosphoric acid ester compound, a condensed phosphoric acid ester compound, a polyphosphoric acid salt compound, red phosphorus, an amine compound, boric acid, a halogen compound, a bromide, a urea-formaldehyde compound, a phosphoric acid salt-urea compound, and ammonium sulfate is added (claim 7);

the flame-retardant knit fabric according to any of claims 1 to 7, which comprises 2 to 20 wt % of an Sb compound (claim 8);

the flame-retardant knit fabric according to any of claims 1 to 4 or claim 8, which comprises the halogen-containing fiber (A) and the cellulosic fiber (B), and/or the polyester fiber (D) (claim 9);

the flame-retardant knit fabric according to claim 9, which comprises 20 to 65 wt % of the halogen-containing fiber (A), 35 to 80 wt % of the cellulosic fiber (B), and 0 to 30 wt % of the polyester fiber (D) (claim 10);

the flame-retardant knit fabric according to claim 1 or any of claims 5 to 8, which comprises the halogen-containing fiber (A) and the flame-retardant cellulosic fiber (C), and/or the polyester fiber (D) (claim 11);

the flame-retardant knit fabric according to claim 11, which comprises 20 to 80 wt % of the halogen-containing fiber (A), 20 to 80 wt % of the flame-retardant cellulosic fiber (C), and 0 to 30 wt % of the polyester fiber (D) (claim 12);

the flame-retardant knit fabric according to claim 1 or any of claims 3 to 8, which comprises the cellulosic fiber (B) and the flame-retardant cellulosic fiber (C), and/or the polyester fiber (D) (claim 13); and

the flame-retardant knit fabric according to claim 13, which comprises 35 to 80 wt % of the cellulosic fiber (B), 20 to 65 wt % of the flame-retardant cellulosic fiber (C), and 0 to 30 wt % of the polyester fiber (D) (claim 14).

The flame-retardant knit fabric of the present invention sufficiently provides texture and amenity inherent in cotton or urethane foam as a material used in upholstered furniture such as mattresses and chairs, bedding products such as pillows, mattress pads, and futon, and the like, and has high flame retardance that can make these products highly flame-retardant.

### BEST MODE FOR CARRYING OUT THE INVENTION

The barrier knit fabric of the present invention is a knit fabric comprising at least two fibers selected from the group consisting of (A) a halogen-containing fiber, (C) a flame-retardant cellulosic fiber, (B) a cellulosic fiber, and (D) a polyester fiber, the knit fabric having a weight per unit area of 150 g/m² or more, having a thickness of 0.5 mm or more, and having a content of a flame retardant and an additive contained in or adhered to the halogen-containing fiber (A) and/or the flame-retardant cellulosic fiber (C) in the whole knit fabric of 2 wt % or more, wherein (weight per unit area of the knit fabric (g/m²))×(thickness of the knit fabric (mm))×(content of the flame retardant and the additive contained in or adhered to the halogen-containing fiber (A) and/or the flame-retardant cellulosic fiber (C) in the whole knit fabric (wt %)/100)=10 or more.

The present invention relates to a knit fabric. The knit fabric is a knit and has a room for vertical and lateral stretching, unlike a fabric woven from warp and weft, and has a small thickness, unlike a nonwoven fabric. Thus, the knit fabric can sufficiently provide texture and amenity inherent in cotton or urethane foam as a material used in upholstered furniture such as mattresses and chairs, bedding products such as pillows, mattress pads, and futon, and the like. Generally, a fiber exhibits a shrinkage behavior in forming a carbonized film when burned, and thus the carbonized film deprived of flexibility is easily cracked. However, the knit fabric has a room for vertical and lateral stretching and thus can provide an extremely good carbonized film without cracking.

The halogen-containing fiber (A) used in the present invention is a component used for improving flame retardance of the flame-retardant knit fabric, and is a component that generates an oxygen-deficient gas when burned to exhibit an effect to help self-extinguishment of the surface flame. Examples of the halogen-containing fiber (A) used in the present invention include, but are not limited to, fibers composed of a homopolymer or copolymer of a halogen-containing monomer such as vinyl chloride or vinylidene chloride; a copolymer of the halogen-containing monomer with a monomer copolymerizable with the halogen-containing monomer, for example, acrylonitrile, styrene, vinyl acetate, or acrylic acid ester; or a graft polymer in which the halogen-containing monomer is grafted to a PVA polymer. Of these halogen-containing fibers (A), a modacrylic fiber composed of a copolymer of a halogen-containing monomer with acrylonitrile is preferably used, because the fiber provides the flame-retardant knit fabric with flame retardance as well as excellent texture, feeling, and design properties.

A flame retardant is preferably added to the modacrylic fiber in order to increase flame retardance of the flame-retardant knit fabric. Specific examples of the flame retardant include antimony compounds such as antimony trioxide, antimony pentoxide, antimonic acid, and antimony oxychloride; Sn compounds such as stannic oxide, metastannic acid, stannous oxyhalide, stannic oxyhalide, stannous hydroxide, and tin tetrachloride, Zn compounds such as zinc oxide; Mg compounds such as magnesium oxide and magnesium hydroxide; Mo compounds such as molybdenum oxide; Ti compounds such as titanium oxide and barium titanate; N compounds such as melamine sulfate and guanidine sulfamate; P compounds such as ammonium polyphosphate and dibutyl aminophosphate; Al compounds such as aluminum hydroxide; Zr compounds such as zirconium oxide; and halogen compounds such as paraffin chloride, hexabromobenzene, and hexabromocyclododecane. Composite compounds such as magnesium stannate, zinc stannate, and zirconium stannate may also be used. These may be used singly or in a combination of two or more. Of these, an antimony compound is preferable, because the compound reacts with a halogen atom eliminated from the modacrylic fiber when burned to produce antimony halide, thereby exhibiting extremely high flame retardance. The antimony compound is added to the modacrylic fiber at 2 wt % or more based on the whole flame-retardant knit fabric in order to maintain flame retardance of the flame-retardant knit fabric, and at 20 wt % or less based on the whole flame-retardant knit fabric in order not to impair texture and strength of the flame-retardant knit fabric. Examples of the modacrylic fiber include, but are not limited to, Kanecaron manufactured by Kaneka Corporation and SEF manufactured by Solutia Inc.

The cellulosic fiber (B) used in the present invention is a component that maintains strength of the flame-retardant knit fabric, provides the flame-retardant knit fabric with excellent comfort such as texture and hygroscopicity, and is effective for forming a carbonized film when burned. Specific examples of the cellulosic fiber (B) include, but are not limited to, cotton, hemp, rayon, polynosic, cupro, acetate, and triacetate. These may be used singly or in a combination of two or more.

The flame-retardant cellulosic fiber (C) used in the present invention is a component that improves flame retardance and maintains strength of the flame-retardant knit fabric, and is a component that provides the flame-retardant knit fabric with excellent comfort such as texture and hygroscopicity, and is effective for forming a carbonized film when burned.

The flame-retardant cellulosic fiber (C) used in the present invention is a silicic acid-containing cellulosic fiber in which a cellulosic fiber contains silicic acid or/and aluminum silicate as a flame retardant, or a flame-retardant cellulosic fiber (C) provided with flame retardance by post-processing or the like using a flame retardant. Specific examples of the cellulosic fiber as a substrate for the flame-retardant cellulosic fiber (C) include, but are not limited to, cotton, hemp, rayon, polynosic, cupro, acetate, and triacetate. These may be used singly or in a combination of two or more.

The silicic acid-containing cellulosic fiber is a cellulosic fiber containing 20 to 50% of silicic acid or/and aluminum silicate as a flame retardant, and typically has a fineness of about 1.7 to 8 dtex and a cut length of about 38 to 128 mm. Specific examples of the fiber include, but are not limited to, Visil of Sateri Oy containing about 30% of silicic acid and Visil AP of Sateri Oy containing about 33% of aluminum silicate.

Examples of the flame retardant used for providing the cellulosic fiber with flame retardance by post-processing or the like include phosphoric acid ester compounds such as triphenyl phosphate, tricresyl phosphate, trixylenyl phosphate, trimethyl phosphate, triethyl phosphate, cresylphenyl phosphate, xylenyldiphenyl phosphate, resorcinol bis(diphenylphosphate), 2-ethylhexyldiphenyl phosphate, dimethylmethyl phosphate, triallyl phosphate (Reofos), an aromatic phosphoric acid ester, a phosphonocarboxylic acid amide derivative, a tetrakis-hydroxymethylphosphonium derivative, and N-methyloldimethylphosphonopropionamide; halogen-containing phosphoric acid ester compounds such as tris(chloroethyl) phosphate, trisdichloropropyl phosphate, tris-β-chloropropyl phosphate, chloroalkyl phosphate, tris(tribromoneopentyl) phosphate, diethyl-N,N-bis(2-hydroxyethyl)aminomethyl phosphate, and tris(2,6-dimethylphenyl) phosphate; condensed phosphoric acid ester compounds such as an aromatic condensed phosphoric acid ester and a halogen-containing condensed phosphoric acid ester; polyphosphoric acid salt compounds such as polyphosphoric acid ammonium amide and polychlorophosphonate; polyphosphoric acid ester compounds such as polyphosphoric acid carbamate; red phosphorus; an amine compound; boric acid, a halogen compound; a bromide; phosphoric acid salt-urea compounds such as an urea-formaldehyde compound and phosphorus-containing aminoplast; ammonium sulfate; and a guanidine condensate. These may be used singly or in a combination of two or more. The flame retardant is added to the cellulosic fiber at 2 wt % or more based on the whole flame-retardant knit fabric in order to maintain flame retardance of the flame-retardant knit fabric, and at 20 wt % or less based on the whole flame-retardant knit fabric in order not to impair texture of the flame-retardant knit fabric.

The polyester fiber (D) used in the present invention is a component to provide the flame-retardant knit fabric of the present invention with excellent texture, feeling, design properties, product strength, washing resistance, and durability, and at the same time has an effect of improving strength of the resulting carbonized film by melting the polyester fiber (D) when burned, and covering the carbonized film with the melt, although the polyester fiber itself is a flammable fiber.

In terms of flame retardance, the flame-retardant knit fabric of the present invention has a weight per unit area of 150 g/m² or more, and preferably 170 g/m² or more, and a thickness of 0.5 mm or more, and preferably 0.8 mm or more. If the weight per unit area is less than 150 g/m², the carbonized film formed has a small density when burned, and the knit fabric has insufficient performance to prevent firing of cotton or urethane foam used in upholstered furniture such as mattresses and chairs and bedding products such as pillows, mattress pads, and futon. If the thickness is less than 0.5 mm, the carbonized film formed has a small thickness when burned, and the knit fabric has insufficient performance to prevent firing of cotton or urethane foam used in upholstered furniture such as mattresses and chairs and bedding products such as pillows, mattress pads, and futon.

The content of the flame retardant in the whole flame-retardant knit fabric of the present invention is 2 wt % or more, and preferably 3 wt % or more. If the content of the flame retardant in the whole knit fabric is less than 2 wt %, the knit fabric has insufficient self-extinguishing ability when burned, and has insufficient performance to prevent firing of cotton or urethane foam used in upholstered furniture such as mattresses and chairs and bedding products such as pillows, mattress pads, and futon.

The flame-retardant knit fabric of the present invention is characterized in that (weight per unit area of the knit fabric (g/m²))×(thickness of the knit fabric (mm))×(content of the flame retardant in the whole knit fabric (wt %))/100=10 or more. In order to make the flame-retardant knit fabric of the present invention exhibit the effect of flame retardance, the weight per unit mass of the knit fabric, the thickness of the knit fabric, and the content of the flame retardant in the whole knit fabric are important, respectively. A combination of these three factors synergistically improves performance of the flame-retardant knit to prevent firing of cotton or urethane foam used in upholstered furniture such as mattresses and chairs and bedding products such as pillows, mattress pads, and futon. If the value of the above calculation formula is less than 10, the synergistic effect of the factors is small, and the flame-retardant knit fabric has decreased performance to prevent firing of cotton or urethane foam used in upholstered furniture such as mattresses and chairs and bedding products such as pillows, mattress pads, and futon.

In the present invention, in order to obtain a flame-retardant knit fabric that is excellent in comfort such as texture and hygroscopicity and has high self-extinguishing properties, the flame-retardant knit fabric comprising the halogen-containing fiber (A) and the cellulosic fiber (B), and/or the polyester fiber (D) according to claim 9 or 10 is provided. The content of the halogen-containing fiber (A), the cellulosic fiber (B), or the polyester fiber (D) is determined according to the comfort such as texture and hygroscopicity, wash resistance, durability, strength of the flame-retardant knit fabric, degree of formation of the carbonized film, and self-extinguishing speed. The content of the halogen-containing fiber (A) is preferably 20 to 65 wt %, the content of the cellulosic fiber (B) is preferably 35 to 80 wt %, and the content of the polyester fiber (D) is preferably 0 to 30 wt %. If the content of the halogen-containing fiber (A) is less than 20 wt %, the flame-retardant knit fabric has insufficient flame retardance, unfavorably. If the content of the cellulosic fiber (B) is less than 35 wt %, the flame-retardant knit fabric has insufficient ability to form a carbonized film when burned, and cannot provide sufficient comfort such as texture and hygroscopicity, unfavorably. The flame-retardant knit fabric can be expected to have improved wash resistance and durability by addition of the polyester fiber (D). However, if the content of the polyester fiber (D) exceeds 30 wt %, the flame-retardant knit fabric has a high content of the polyester fiber (D) and has inferior flame retardance, unfavorably.

In the present invention, in order to obtain a flame-retardant knit fabric that is excellent in comfort such as texture and hygroscopicity and is provided with high flame retardance, the flame-retardant knit fabric comprising the halogen-containing fiber (A) and the flame-retardant cellulosic fiber (C), and/or the polyester fiber (D) according to claim 1 or 12 is provided. The content of the halogen-containing fiber (A), the flame-retardant cellulosic fiber (C), or the polyester fiber (D) is determined according to the comfort such as texture and hygroscopicity, wash resistance, durability, strength of the flame-retardant knit fabric, degree of formation of the carbonized film, and self-extinguishing speed. The content of the halogen-containing fiber (A) is preferably 20 to 80 wt %, and the content of the flame-retardant cellulosic fiber (C) is preferably 20 to 80 wt %. If the content of the halogen-containing fiber (A) is less than 20 wt %, the self-extinguishing speed of the flame-retardant knit fabric is not sufficiently increased, unfavorably. If the content of the flame-retardant cellulosic fiber (C) is less than 20 wt %, the flame-retardant knit fabric has insufficient ability to form a carbonized film when burned, and cannot provide sufficient comfort such as texture and hygroscopicity, unfavorably. The flame-retardant knit fabric can be expected to have improved wash resistance and durability by addition of the polyester fiber (D). However, if the content of the polyester fiber (D) exceeds 30 wt %, the flame-retardant knit fabric has a high content of the polyester fiber (D) and has inferior flame retardance, unfavorably.

In the present invention, in order to obtain a flame-retardant knit fabric that provides higher comfort such as texture and hygroscopicity of the cellulosic fiber (B) and has high flame retardance, the flame-retardant knit fabric comprising the flame-retardant cellulosic fiber (C) and the cellulosic fiber (B), and/or the polyester fiber (D) according to claim 13 or 14 is provided. The content of the flame-retardant cellulosic fiber (C), the cellulosic fiber (B), or the polyester fiber (D) is determined according to the comfort such as texture and hygroscopicity, wash resistance, durability, and degree of flame retardance. The content of the flame-retardant cellulosic fiber (C) is preferably 20 to 65 wt %, and the content of the cellulosic fiber (B) is preferably 35 to 80 wt %. If the content of the flame-retardant cellulosic fiber (C) is less than 20 wt %, the flame-retardant knit fabric has insufficient flame retardance, unfavorably. If the content of the flame-retardant cellulosic fiber (C) is more than 80 wt %, the flame-retardant knit fabric provides insufficient texture and comfort, unfavorably, because the flame-retardant cellulosic fiber is inferior in feeling to cellulose not having flame retardance. The flame-retardant knit fabric can be expected to have improved wash resistance and durability by addition of the polyester fiber (D). However, if the content of the polyester fiber (D) exceeds 30 wt %, the flame-retardant knit fabric has a high content of the polyester fiber (D) and has inferior flame retardance, unfavorably.

The flame-retardant knit fabric of the present invention comprises at least two fibers selected from the group consisting of the halogen-containing fiber (A), the cellulosic fiber (B), the flame-retardant cellulosic fiber (C), and the polyester fiber (D) as described above. Examples of the method of forming the flame-retardant knit fabric comprising at least two fibers include, but are not limited to, blending, mix spinning, interknitting, and knit fabric overlapping.

There are no specific limitations to the method of knitting the flame-retardant knit fabric of the present invention, and either weft knitting or warp knitting is possible. There are no specific limitations to the shape of the knit fabric, and the knit fabric may be a pile knit fabric having a raised surface.

The flame-retardant knit fabric of the present invention is suitably used for applications in which flame-shielding performance is necessary. The term “flame-shielding performance” used herein refers to performance in which the flame-retardant knit fabric is carbonized to shield the flame and prevent spreading of the flame to the opposite side when the flame-retardant knit fabric is exposed to the flame.

The flame-retardant knit fabric of the present invention may be used singly, or two or more such knit fabrics may be used as overlapped. By overlapping two or more such knit fabrics, there may be provided a flame-retardant knit fabric comprising at least two fibers selected from the group consisting of the halogen-containing fiber (A), the cellulosic fiber (B), the flame-retardant cellulosic fiber (C), and the polyester fiber (D), the knit fabric having a weight per unit area of 150 g/m² or more, having a thickness of 0.5 mm or more, and having a content of a flame retardant contained in or adhered to the halogen-containing fiber (A) and the flame-retardant cellulosic fiber (C) in the whole knit fabric of 2 wt % or more, wherein (weight per unit area of the knit fabric (g/m²))×(thickness of the knit fabric (mm))×(content of the flame retardant contained in or adhered to the halogen-containing fiber (A) and the flame-retardant cellulosic fiber (C) in the whole knit fabric (wt %)/100)=10 or more.

The flame-retardant knit fabric may contain an antistatic agent, a thermal coloration inhibitor, a light resistance improver, a whiteness improver, a matting inhibitor, or the like as necessary.

The flame-retardant knit fabric of the present invention thus obtained has desired flame retardance and provides excellent properties such as texture, feeling, hygroscopicity, design properties, and comfort.

When a textile product is produced using the flame-retardant knit fabric of the present invention, a textile product can be obtained which has an excellent property of the flame-retardant knit fabric of the present invention, specifically, has excellent flame retardance; provides excellent properties such as texture, feeling, hygroscopicity, design properties, and comfort; and exhibits properties inherent in the textile product. Specifically, a textile product can be obtained which has flame retardance to allow the textile product to resist the flame over a long time without impairing comfort such as texture or feeling in upholstered furniture or bedding products.

### EXAMPLES

The present invention will be described in more detail below with reference to examples. However, the present invention is not limited to these examples.

(Method for Evaluating Flame Retardance)

Flame retardance of flame-retardant knit fabrics in examples was evaluated based on British BS5852: Part 2: 1982 Ignition source 5 Schedule 3. The British BS5852: Part 2: 1982 Ignition source 5 Schedule 3 flammability test method will be briefly described as follows. Urethane foam is covered with a flame-retardant knit fabric. The seat and the back of the urethane foam is further covered with a flame-retardant polyester fabric (Trevira), with the seat and the back set to be perpendicular to each other. A timberwork crib (4 cm×4 cm (base)×6.5 cm (height)) is placed on the contact area between the seat and the back. The crib is soaked with 1.4 ml of 2-propanol and then flamed. Flame retardance of the flame-retardant knit fabric is judged with respect to the afterflame, afterglow, smouldering, and carbonized length. A flame-retardant knit fabric is acceptable if the fabric exhibits no afterflame 30 minutes after the flaming and no afterflow or smouldering 60 minutes after the flaming and has a carbonized length from the edge of the crib of less than 10 cm.

Flame retardance of a flame-retardant knit fabric is evaluated based on the above criteria, and a flame-retardant knit fabric unacceptable is indicated as “Poor”. Among flame-retardant knit fabrics acceptable, a fabric with no afterflame seven minutes after the flaming is indicated as “Very Good”, a fabric with no afterflame 10 minutes after the flaming is indicated as “Good”, and a fabric other than these fabrics is indicated as “Fair”. Among flame-retardant knit fabrics acceptable, a fabric with no afterflow or smouldering 10 minutes after the flaming is indicated as “Very Good”, a fabric with no afterflow or smouldering 20 minutes after the flaming is indicated as “Good”, and a fabric other than these fabrics is indicated as “Fair”.

### Production Example 1 (Production of Halogen-Containing Fiber (A))

52 parts by weight of acrylonitrile, 46.8 parts by weight of vinylidene chloride, and 1.2 parts by weight of sodium styrenesulfonate were copolymerized, and the resulting copolymer was dissolved in acetone to provide a 30 wt % solution. Then, 26 parts by weight of antimony trioxide was added to 100 parts by weight of the copolymer to prepare a spinning solution. The resulting spinning solution was extruded into a 38 wt % aqueous acetone solution at 25° C. using a nozzle having a hole size of 0.07 mm and 33,000 holes, washed with water, and then dried at 120° C. for eight minutes. Thereafter, the spinning solution was drawn at a ratio of 3.0 at 150° C. and thermally treated at 175° C. for 30 seconds to obtain a halogen-containing fiber (A) having a fineness of 2 dtex. A finishing oil agent for spinning (manufactured by Takemoto Oil & Fat Co., Ltd.) was fed to the resulting halogen-containing flame-retardant fiber. The fiber was crimped and cut into a length of 51 mm. Then, a spun yarn having a metric count of 34 was produced.

### Production Example 2 (Production of Halogen-Containing Fiber (A))

A spun yarn having a metric count of 34 was produced in the same manner as in Production Example 1, except for preparing a spinning solution by adding 18 parts by weight of antimony trioxide.

### Production Example 3 (Production of Halogen-Containing Fiber (A))

A spun yarn having a metric count of 34 was produced in the same manner as in Production Example 1, except for preparing a spinning solution by adding 10 parts by weight of antimony trioxide.

### Production Example 4 (Production of Halogen-Containing Fiber (A))

A spun yarn having a metric count of 34 was produced in the same manner as in Production Example 1, except for preparing a spinning solution by adding 4 parts by weight of antimony trioxide.

### Production Example 5 (Preparation of Flame-Retardant Rayon Fiber)

A spun yarn having a metric count of 34 was produced from a rayon fiber (fineness: 1.5 dtex, cut length: 38 mm), and ammonium polyphosphate (manufactured by Suzuhiro Chemical Co., Ltd., FCP-730) as a flame retardant was added to the spun yarn composed of the rayon fiber at a ratio of 20 wt %.

### Example 1 (Preparation of Knit Fabric)

From the spun yarn having a metric count of 34, composed of a halogen-containing fiber (A), and prepared in Production Example 1 and a spun yarn having a metric count of 34 and composed of a cotton fiber, a knit fabric having a weight per unit area of 170 g/m² and containing 55 wt % of the halogen-containing fiber (A) and 45 wt % of the cotton fiber was prepared using a known circular knitting machine. The results of evaluating flame retardance of the resulting knit fabric are shown in Table 1.

TABLE 1

| | Mixing ratio of fiber in fabric (wt %) | | | Structure of knit fabric | | | |
|---|---|---|---|---|---|---|---|
| | Halogen- | | | Flame | Weight per | | |
| | containing | Cotton | Polyester | retardant in | unit area | Thickness | Coefficient |
| Example No. | fiber | fiber | fiber | fabric (wt %) | (g/m²) | (mm) | (A × B × C/100) |
| Example 1 | 55 | 45 | 0 | 10.8 | 170 | 0.6 | 11.0 |
| Example 2 | 39 | 61 | 0 | 4.6 | 290 | 1.1 | 14.7 |
| Example 3 | 25 | 75 | 0 | 2.2 | 330 | 1.4 | 10.2 |
| Example 4 | 65 | 35 | 0 | 2.4 | 370 | 1.2 | 10.7 |
| Example 5 | 28 | 46 | 26 | 2.5 | 313 | 1.4 | 11.0 |
| Comparative Example 1 | 55 | 45 | 0 | 10.8 | 145 | 0.6 | 9.4 |
| Comparative Example 2 | 35 | 65 | 0 | 3.1 | 290 | 1.0 | 9.0 |
| Comparative Example 3 | 25 | 46 | 26 | 2.2 | 311 | 1.3 | 8.9 |

| Flammability test | |
|---|---|
| Afterflame | Smouldering |

| Example No. | min | Judgment | min | Judgment | Overall Judgment |
|---|---|---|---|---|---|
| Example 1 | 6 | Very good | 15 | Good | Acceptable |
| Example 2 | 10 | Good | 15 | Good | Acceptable |
| Example 3 | 13 | Fair | 21 | Fair | Acceptable |
| Example 4 | 12 | Fair | 22 | Fair | Acceptable |
| Example 5 | 15 | Fair | 22 | Fair | Acceptable |
| Comparative Example 1 | Forcibly extinguished | Poor | — | — | Unacceptable |
| Comparative Example 2 | Forcibly extinguished | Poor | — | — | Unacceptable |
| Comparative Example 3 | Forcibly extinguished | Poor | — | — | Unacceptable |

### Example 2 (Preparation of Knit Fabric)

A knit fabric was prepared in the same manner as in Example 1, except for using the spun yarn having a metric count of 34, composed of a halogen-containing fiber (A), and prepared in Production Example 2. The resulting knit fabric was a knit fabric having a weight per unit area of 290 g/m² and containing 39 wt % of the halogen-containing fiber (A) and 61 wt % of the cotton fiber. The results of evaluating flame retardance of the resulting knit fabric are shown in Table 1.

### Example 3 (Preparation of Knit Fabric)

A knit fabric was prepared in the same manner as in Example 1, except for using the spun yarn having a metric count of 34, composed of a halogen-containing fiber (A), and prepared in Production Example 3. The resulting knit fabric was a knit fabric having a weight per unit area of 310 g/m² and containing 25 wt % of the halogen-containing fiber (A) and 75 wt % of the cotton fiber. The results of evaluating flame retardance of the resulting knit fabric are shown in Table 1.

### Example 4 (Preparation of Knit Fabric)

A knit fabric was prepared in the same manner as in Example 1, except for using the spun yarn having a metric count of 34, composed of a halogen-containing fiber (A), and prepared in Production Example 4. The resulting knit fabric was a knit fabric having a weight per unit area of 370 g/m² and containing 65 wt % of the halogen-containing fiber (A) and 35 wt % of the cotton fiber. The results of evaluating flame retardance of the resulting knit fabric are shown in Table 1.

### Comparative Example 1 (Preparation of Knit Fabric)

A knit fabric was prepared in the same manner as in Example 1, using the spun yarn having a metric count of 34, composed of a halogen-containing fiber (A), and prepared in Production Example 1. The resulting knit fabric was a knit fabric having a weight per unit area of 145 g/m² and containing 55 wt % of the halogen-containing fiber (A) and 45 wt % of the cotton fiber. The results of evaluating flame retardance of the resulting knit fabric are shown in Table 1.

### Comparative Example 2 (Preparation of Knit Fabric)

A knit fabric was prepared in the same manner as in Example 1, using the spun yarn having a metric count of 34, composed of a halogen-containing fiber (A), and prepared in Production Example 3. The resulting knit fabric was a knit fabric having a weight per unit area of 290 g/m² and containing 35 wt % of the halogen-containing fiber (A) and 65 wt % of the cotton fiber. The results of evaluating flame retardance of the resulting knit fabric are shown in Tables 1 and 3.

As shown in Table 1, the knit fabrics of Examples 1 to 4 had good flame retardance. In contrast, the knit fabric of Comparative Example 1 had insufficient flame retardance, because the knit fabric had a weight per unit area smaller than that of the knit fabric of Example 1. The knit fabric of Comparative Example 2 had a certain content of the flame retardant, a certain weight per unit area, and a certain thickness, but had a small coefficient and exhibited a small synergistic effect of these factors, and thus had inferior flame retardance.

### Example 5 (Preparation of Knit Fabric)

A knit fabric was prepared in the same manner as in Example 1, except for using the spun yarn having a metric count of 34, composed of a halogen-containing fiber (A), and prepared in Production Example 1, a spun yarn having a metric count of 34 and composed of a cotton fiber, and a spun yarn having a metric count of 20 and composed of a polyester fiber (D). The resulting knit fabric was a knit fabric having a weight per unit area of 313 g/m² and containing 28 wt % of the halogen-containing fiber (A), 46 wt % of the cotton fiber, and 26 wt % of the polyester fiber (D). The results of evaluating flame retardance of the resulting knit fabric are shown in Table 1.

### Comparative Example 3 (Preparation of Knit Fabric)

A knit fabric having a weight per unit area of 311 g/m² and containing 25 wt % of a halogen-containing fiber (A), 46 wt % of a cotton fiber, and 26 wt % of a polyester fiber (D) was obtained in the same manner as in Example 4. The results of evaluating flame retardance of the resulting knit fabric are shown in Table 1.

As shown in Table 1, the knit fabric of Example 5 had good flame retardance. In contrast, the knit fabric of Comparative Example 3 had a certain content of the flame retardant, a certain weight per unit area, and a certain thickness as compared with the knit fabric of Example 5, but had a small coefficient and exhibited a small synergistic effect of these factors, and thus had inferior flame retardance.

### Example 6 (Preparation of Knit Fabric)

A knit fabric was prepared in the same manner as in Example 1 using the spun yarn having a metric count of 34, composed of a halogen-containing fiber (A), and prepared in Production Example 2, and a spun yarn having a metric count of 34 and composed of Visil manufactured by Sateri Oy as a silicic acid-containing rayon fiber (fineness: 1.7 dtex, cut length: 40 mm). The resulting knit fabric was a knit fabric having a weight per unit area of 290 g/m² and containing 35 wt % of the halogen-containing fiber (A) and 65 wt % of the silicic acid-containing rayon fiber. The results of evaluating flame retardance of the resulting knit fabric are shown in Table 2.

TABLE 2

| | Mixing ratio of fiber in fabric (wt %) | | | | Structure of knit fabric | | | |
|---|---|---|---|---|---|---|---|---|
| | Halogen- | Silicic acid- | Post- | | Flame | Weight per | | |
| | containing | containing | processed | Cotton | retardant in | unit area | Thickness | Coefficient |
| Example No. | fiber | rayon fiber | rayon fiber | fiber | fabric (wt %) | (g/m²) | (mm) | (A × B × C/100) |
| Example 6 | 35 | 65 | | | 22.6 | 290 | 1.1 | 72.1 |
| Example 7 | 35 | | 65 | | 14.0 | 290 | 1.1 | 44.7 |
| Comparative Example 2 | 35 | | | 65 | 3.1 | 290 | 1.0 | 9.0 |

| Flammability test | |
|---|---|
| Afterflame | Smouldering |

| Example No. | min | Judgment | min | Judgment | Overall judgment |
|---|---|---|---|---|---|
| Example 6 | 13 | Fair | 17 | Good | Acceptable |
| Example 7 | 10 | Good | 15 | Good | Acceptable |
| Comparative Example 2 | Forcibly extinguished | Bad | — | — | Unacceptable |

### Example 7 (Preparation of Knit Fabric)

A knit fabric was prepared in the same manner as in Example 1, using the spun yarn having a metric count of 34, composed of a halogen-containing fiber (A), and prepared in Production Example 3, and the spun yarn having a metric count of 34, composed of a flame-retardant rayon fiber, and prepared in Production Example 5. The resulting knit fabric was a knit fabric having a weight per unit area of 290 g/m² and containing 35 wt % of the halogen-containing fiber (A) and 65 wt % of the flame-retardant rayon fiber. The results of evaluating flame retardance of the resulting knit fabric are shown in Table 2.

As shown in Table 2, the knit fabric of Comparative Example 1 had a certain content of the flame retardant, a certain weight per unit area, and a certain thickness, but had a small coefficient and exhibited a small synergistic effect of these factors, and thus had inferior flame retardance. In contrast, the knit fabrics of Examples 6 and 7 contained large amounts of the flame retardant and the additive, and thus had a sufficiently high coefficient and were acceptable in terms of flame retardance.

### Example 8 (Preparation of Knit Fabric)

A knit fabric was prepared in the same manner as in Example 1 using a spun yarn having a metric count of 34 and composed of Visil manufactured by Sateri Oy as a silicic acid-containing rayon fiber (fineness: 1.7 dtex, cut length: 40 mm) and a spun yarn having a metric count of 34 and composed of a cotton fiber. The resulting knit fabric was a knit fabric having a weight per unit area of 285 g/m² and containing 35 wt % of the silicic acid-containing rayon fiber and 65 wt % of the cotton fiber. The results of evaluating flame retardance of the resulting knit fabric are shown in Table 3.

TABLE 3

| | Mixing ratio of fiber in fabric (wt %) | | | Structure of knit fabric | | | |
|---|---|---|---|---|---|---|---|
| | Silicic acid- | Post- | | Flame | Weight per | | |
| | containing | processed | Cotton | retardant in | unit area | Thickness | Coefficient |
| Example No. | rayon fiber | rayon fiber | fiber | fabric (wt %) | (g/m²) | (mm) | (A × B × C/100) |
| Example 8 | 35 | | 65 | 10.5 | 285 | 1.1 | 32.9 |
| Example 9 | | 35 | 65 | 5.8 | 287 | 1.1 | 18.3 |
| Comparative Example 4 | 10 | | 90 | 3.0 | 290 | 1.1 | 9.6 |
| Comparative Example 5 | | 15 | 85 | 2.5 | 303 | 1.2 | 9.1 |

| Flammability test | |
|---|---|
| Afterflame | Smouldering |

| Example No. | min | Judgment | min | Judgment | Overall judgment |
|---|---|---|---|---|---|
| Example 8 | 16 | Fair | 21 | Fair | Acceptable |
| Example 9 | 13 | Fair | 17 | Good | Acceptable |
| Comparative Example 4 | Forcibly extinguished | Bad | — | — | Unacceptable |
| Comparative Example 5 | Forcibly extinguished | Bad | — | — | Unacceptable |

### Example 9 (Preparation of Knit Fabric)

A knit fabric was prepared in the same manner as in Example 1, using the spun yarn having a metric count of 34, composed of a flame-retardant rayon fiber, and prepared in Production Example 5, and a spun yarn having a metric count of 34 and composed of a cotton fiber. The resulting knit fabric was a knit fabric having a weight per unit area of 287 g/m² and containing 35 wt % of the flame-retardant rayon fiber and 65 wt % of the cotton fiber. The results of evaluating flame retardance of the resulting knit fabric are shown in Table 3.

### Comparative Example 4 (Preparation of Knit Fabric)

A knit fabric was prepared in the same manner as in Example 1 using a spun yarn having a metric count of 34 and composed of Visil manufactured by Sateri Oy as a silicic acid-containing rayon fiber (fineness: 1.7 dtex, cut length: 40 mm) and a spun yarn having a metric count of 34 and composed of a cotton fiber. The resulting knit fabric was a knit fabric having a weight per unit area of 290 g/m² and containing 15 wt % of the silicic acid-containing rayon fiber and 85 wt % of the cotton fiber. The results of evaluating flame retardance of the resulting knit fabric are shown in Table 3.

### Comparative Example 5 (Preparation of Knit Fabric)

A knit fabric was prepared in the same manner as in Example 1, using the spun yarn having a metric count of 34, composed of a flame-retardant rayon fiber, and prepared in Production Example 5, and a spun yarn having a metric count of 34 and composed of a cotton fiber. The resulting knit fabric was a knit fabric having a weight per unit area of 303 g/m² and containing 18 wt % of the flame-retardant rayon fiber and 82 wt % of the cotton fiber. The results of evaluating flame retardance of the resulting knit fabric are shown in Table 3.

As shown in Table 3, the knit fabrics of Examples 8 and 9 had good flame retardance, but the knit fabrics of Comparative Examples 4 and 5 had inferior flame retardance, because the knit fabric of Comparative Example 4 had a low content of the silicic acid-containing rayon fiber and the knit fabric of Comparative Example 5 had a low content of the flame-retardant rayon fiber.

1. A flame-retardant knit fabric comprising at least two fibers selected from the group consisting of (A) a halogen-containing fiber, (B) a cellulosic fiber, (C) a flame-retardant cellulosic fiber, and (D) a polyester fiber, the knit fabric having a weight per unit area of 150 g/m² or more, having a thickness of 0.5 mm or more, and having a content of a flame retardant in the whole knit fabric of 2 wt % or more, wherein (weight per unit area of the knit fabric (g/m²))×(thickness of the knit fabric (mm))×(content of the flame retardant in the whole knit fabric (wt %)/100)=10 or more.

2. The flame-retardant knit fabric according to claim 1, wherein the halogen-containing fiber (A) is a modacrylic fiber.

3. The flame-retardant knit fabric according to claim 1, wherein the cellulosic fiber (B) is at least one fiber selected from the group consisting of cotton, hemp, rayon, polynosic, cupro, acetate, and triacetate.

4. The flame-retardant knit fabric according to claim 3, wherein the cellulosic fiber (B) is a cotton fiber.

5. The flame-retardant knit fabric according to claim 1, wherein the flame-retardant cellulosic fiber (C) is at least one fiber selected from the group consisting of cotton, hemp, rayon, polynosic, cupro, acetate, and triacetate.

6. The flame-retardant knit fabric according to claim 5, wherein the flame-retardant cellulosic fiber (C) is a rayon fiber containing 20 to 50 wt % of a flame retardant selected from silicic acid and aluminum silicate.

7. The flame-retardant knit fabric according to claim 5 or 6, wherein the flame-retardant cellulosic fiber (C) is the cellulosic fiber (B) to which 6 to 25 wt % of a flame retardant selected from the group consisting of a phosphoric acid ester compound, a halogen-containing phosphoric acid ester compound, a condensed phosphoric acid ester compound, a polyphosphoric acid salt compound, red phosphorus, an amine compound, boric acid, a halogen compound, a bromide, a urea-formaldehyde compound, a phosphoric acid salt-urea compound, and ammonium sulfate is added.

8. The flame-retardant knit fabric according to claim 1, which comprises 2 to 20 wt % of an Sb compound.

9. The flame-retardant knit fabric according to claim 1, which comprises the halogen-containing fiber (A) and the cellulosic fiber (B), and/or the polyester fiber (D).

10. The flame-retardant knit fabric according to claim 9, which comprises 20 to 65 wt % of the halogen-containing fiber (A), 35 to 80 wt % of the cellulosic fiber (B), and 0 to 30 wt % of the polyester fiber (D).

11. The flame-retardant knit fabric according to claim 1, which comprises the halogen-containing fiber (A) and the flame-retardant cellulosic fiber (C), and/or the polyester fiber (D).

12. The flame-retardant knit fabric according to claim 11, which comprises 20 to 80 wt % of the halogen-containing fiber (A), 20 to 80 wt % of the flame-retardant cellulosic fiber (C), and 0 to 30 wt % of the polyester fiber (D).

13. The flame-retardant knit fabric according to claim 1, which comprises the cellulosic fiber (B) and the flame-retardant cellulosic fiber (C), and/or the polyester fiber (D).

14. The flame-retardant knit fabric according to claim 13, which comprises the cellulosic fiber (B), 20 to 65 wt % of the flame-retardant cellulosic fiber (C), and 0 to 30 wt % of the polyester fiber (D).
